(19) United States
(12) Patent Application Publication
(10) Pub. No.: US 2020/0330906 A1
(43) Pub. Date: Oct. 22, 2020

(54) FILTER ELEMENT AND FILTER DEVICE

(71) Applicant: KYOSAN DENKI CO., LTD., Koga-city (JP)

(72) Inventors: Takanori TSUNEKAWA, Koga-city (JP); Fumiya KOMINE, Koga-city (JP); Takafumi KATO, Koga-city (JP); Akihiro KIMURA, Koga-city (JP)

(21) Appl. No.: 16/921,576

(22) Filed: Jul. 6, 2020

Related U.S. Application Data
(63) Continuation of application No. PCT/JP2018/035240, filed on Sep. 24, 2018.

(30) Foreign Application Priority Data
Jan. 10, 2018 (JP) 2018-002129

(51) Int. Cl. B01D 29/11; B01D 35/30

(52) U.S. Cl. CPC B01D 29/11; B01D 2201/40; B01D 2201/30; B01D 35/30

(57) ABSTRACT

A filter device comprises a case and a filter element. The case has a fixed cylinder and a movable cylinder. The fixed cylinder and the movable cylinder provide a valve mechanism. A biasing member is arranged between the fixed cylinder and the movable cylinder. The filter element and the support cylinder are meshed with each other by a meshing mechanism. The meshing mechanism is provided by a movable cylinder meshing portion and a frame meshing portion. The meshing mechanism prevents rotation of the filter element with respect to the tightening direction.

### CROSS REFERENCE TO RELATED APPLICATION

The present application is a continuation application of International Patent Application No. PCT/JP2018/035240 filed on Sep. 24, 2018, which designated the U.S. and claims the benefit of priority from Japanese Patent Application No. 2018-2129 filed in Japan filed on Jan. 10, 2018, the entire disclosure of the above application is incorporated herein by reference.

### TECHNICAL FIELD

The disclosure in this specification relates to a filter element and a filter device.

### BACKGROUND

A filter device may be configured to allow replacement of a filter element. The filter device and the filter element maintain filtering function after a replacement. In view of the above or other aspects not mentioned, further improvements are needed in a filter element and a filter device.

### SUMMARY

A filter device disclosed herein comprises: a case having a first case and a second case which is rotated in a tightening direction and is coupled to the first case so as to cover an opening end of the first case; a fixed cylinder fixed to the case, the fixed cylinder providing an outlet passage therein; a movable cylinder which is movably supported in a direction of an axis with respect to the fixed cylinder and fixed around the axis with respect to the fixed cylinder; a valve mechanism formed between the fixed cylinder and the movable cylinder, which opens at a position where the movable cylinder is pushed in and closes at a position where the movable cylinder extends; an biasing member which biases the movable cylinder in a direction in which the movable cylinder is extended with respect to the fixed cylinder; a cylindrical filter element arranged in the case so as to cover a support cylinder including the fixed cylinder and the movable cylinder; a seal member disposed between the filter element and the support cylinder, for partitioning a dirty side before being filtered by the filter element and a clean side after being filtered by the filter element; and a meshing mechanism formed at a contact portion between the support cylinder and the filter element, and meshing with each other so as to prevent rotation of the filter element in the tightening direction.

According to the disclosed filter device, the meshing mechanism provides meshing to prevent rotation of the filter element with respect to the tightening direction. As a result, when the first case and the second case are relatively operated in the tightening direction, the accompanying rotation of the filter element is prevented. Thereby, the stress applied to the seal member is suppressed, and the damage of the seal member is suppressed.

A filter device disclosed herein comprises: a case having a first case and a second case which is coupled to the first case so as to cover an opening end of the first case; a cylindrical filter element arranged in the case; and a support cylinder arranged in the case and extending in a direction of the axis of the filter element. The support cylinder includes: a fixed cylinder fixed to the case, the fixed cylinder providing an outlet passage therein; a movable cylinder which is movably supported in a direction of an axis with respect to the fixed cylinder and fixed around the axis with respect to the fixed cylinder; a valve mechanism formed between the fixed cylinder and the movable cylinder, which opens at a position where the movable cylinder is pushed in and closes at a position where the movable cylinder extends; a biasing member which biases the movable cylinder in a direction in which the movable cylinder is extended with respect to the fixed cylinder; and an engaging mechanism which engages the movable cylinder to the fixed cylinder so that a movement of the movable cylinder in the axial direction with respect to the fixed cylinder is allowed only by a predetermined restricted distance. The filter element includes a filter medium arranged in a cylindrical shape around the axis; and a frame which supports the filter medium, wherein the frame includes: a support portion which supports the filter medium; and a protruding portion provided on the support portion and protruding from the filter medium along the axis. The filter element 30 is arranged by compressing the biasing member when the first case and the second case are coupled to each other at a prescribed position, and wherein the restricted distance allowed by the engaging mechanism is a distance that causes at least a portion of the protruding portion of the filter element to protrude from the opening end of the first case when the first case and the second case are separated.

According to the disclosed filter device, the engaging mechanism can lift the filter element in the restricted distance. When the first case and the second case are separated, the restricted distance is a distance which makes at least a part of the protruding portion of the filter element be projected from the opening end of the first case. As a result, an operator can operate the protruding portion of the filter element.

A filter element disclosed herein comprises: a filter medium arranged in a cylindrical shape around an axis; and a frame which supports the filter medium, wherein the frame includes: a support portion which supports the filter medium; and a protruding portion provided on the support portion and protruding from the filter medium along the axis.

The disclosed filter medium has a protruding portion that protrudes axially from the filter media. As a result, an operator may operate the protruding portion while suppressing contact with the filter medium.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

### BRIEF DESCRIPTION OF DRAWINGS

In the drawings:

FIG. 1 is a cross-sectional view of a filter device according to a first embodiment;

FIG. 2 is a side view showing an outer appearance of a filter element;

FIG. 3 is a perspective view of an upper part of the filter element;

FIG. 4 is a perspective view of a lower portion of the filter element;

FIG. 5 is a bottom view of the filter element;

FIG. 6 is an enlarged perspective view showing an inside of the filter element;

FIG. 7 is a developed sectional view showing a meshing mechanism;

FIG. 8 is a developed sectional view showing the meshing mechanism;

FIG. 9 is a side view showing an example of replacement work;

FIG. 10 is a plan view of the filter element;

FIG. 11 is a frontal view of the filter element;

FIG. 12 is a side view of the filter element;

FIG. 13 is a bottom view of the filter element;

FIG. 14 is a perspective view of an upper portion of the filter element;

FIG. 15 is a perspective view of a lower portion of the filter element;

FIG. 16 is a sectional view of the filter element;

FIG. 17 is a sectional view showing a meshing mechanism according to a second embodiment;

FIG. 18 is a cross sectional view showing a support cylinder according to a third embodiment;

FIG. 19 is a cross sectional view showing the support cylinder according to the third embodiment; and

FIG. 20 is a cross-sectional view of a filter device according to a fourth embodiment.

### DESCRIPTION OF EMBODIMENT

Hereinafter, a plurality of embodiments will be described with reference to the drawings. In some embodiments, parts which are functionally and/or structurally corresponding and/or associated are given the same reference numerals, or reference numerals with different hundreds digit or higher digits. For corresponding parts and/or associated parts, reference can be made to the description of other embodiments.

### First Embodiment

<System>

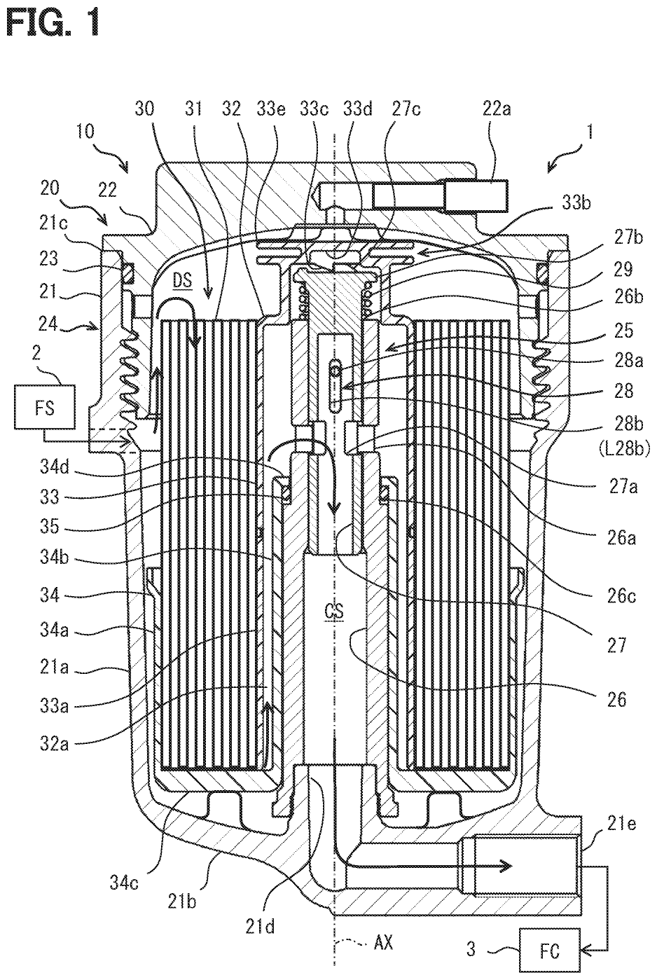

In FIG. 1, the filter system 1 has a fluid source 2 (FS) that supplies a fluid and a utilization device 3 (FC) that utilizes the fluid. A filter device 10 that removes foreign matter by filtering the fluid is provided between the fluid source 2 and the utilization device 3. The fluid is, for example, a liquid. The fluid is, for example, fuel such as light oil, ethanol and gasoline. The filter system 1 is also a fuel system. The fluid source 2 may include a tank for storing fuel. The utilization device 3 is, for example, a consumption device that consumes fuel. The utilization device 3 is provided by, for example, an internal combustion engine. The filter system 1 may include a pump that supplies fuel. The pump may be provided in the fluid source 2 or the utilization device 3. The filter device 10 may be arranged downstream of the pump or upstream of the pump.

<Filter Device>

The filter device 10 filters the fuel supplied from the fluid source 2, removes foreign substances, and supplies a purified fuel to the utilization device 3. The filter device 10 includes a case 20 and a filter element 30. The case 20 provides a passage for fluid. The case 20 houses the filter element 30 across the passage. The filter element 30 partitions an inside of the case 20 into a dirty side (DS) before being filtered by the filter element 30 and a clean side (CS) after being filtered by the filter element 30.

<Case>

The case 20 has a first case 21 and a second case 22. A seal member 23 is arranged between the first case 21 and the second case. The seal member 23 is provided by an O-ring or the like.

The first case 21 has a cup shape. The first case 21 has a cylindrical outer wall 21a, a bottom wall 21b that covers one end (bottom portion) of the outer wall 21a, and an opening end 21c at the other end of the outer wall 21a. The outer wall 21a has a cylindrical shape extending along the axis AX. Further, the first case 21 has an outlet pipe 21d that protrudes inward from the bottom wall 21b. The outer wall 21a has an inlet that receives fuel from the fluid source 2. The inlet is not shown. The outlet pipe 21d communicates with an outlet 21e.

The second case 22 has a cap shape that covers the opening end 21c of the first case 21. The second case 22 is housed in the first case 21 from the opening end 21c of the first case 21. The second case 22 has a plug 22a for bleeding air.

The first case 21 and the second case 22 are fastened by a fastening mechanism 24. The fastening mechanism 24 is provided by a screw mechanism. The screw mechanism is provided by a male screw and a female screw around the axis AX. The second case 22 is coupled to the first case 21 so as to cover the opening end 21c of the first case 21 by being rotated in a tightening direction. The first case 21 and the second case 22 are rotated one or more times in the tightening direction, and are tightened into a proper position. The first case 21 and the second case 22 are loosened by rotated in a loosening direction opposite to the tightening direction. The first case 21 and the second case 22 are separated by being rotated in the loosening direction.

<Support Cylinder>

The case 20 has a support cylinder 25. The support cylinder 25 is a cylindrical member extending along the axis AX. The support cylinder 25 provides a member that supports the filter element 30. The support cylinder 25 provides an outlet passage as the clean side CS. Further, the support cylinder 25 provides a seal surface 26c with which the seal member 35 partitioning the clean side CS and the dirty side DS comes into contact. The support cylinder 25 includes a fixed cylinder 26 and a movable cylinder 27. The fixed cylinder 26 and the movable cylinder 27 are arranged in an inside and outside double layered manner. The case 20, the fixed cylinder 26, and the movable cylinder 27 may be made of resin or metal such as aluminum alloy.

The fixed cylinder 26 is fixed to the case 20. The fixed cylinder 26 is screwed into the first case 21. The fixed cylinder 26 provides an outlet passage therein. The fixed cylinder 26 has a fixed opening 26a that provides a valve mechanism described later. The fixed opening 26a is formed by penetrating the wall of the fixed cylinder 26 in an inside and outside manner. The fixed cylinder 26 has a plurality of fixed openings 26a that are arranged in a distributed manner along the circumferential direction of the fixed cylinder 26. The fixed cylinder 26 has an opening end 26b at a tip end. The opening end 26b receives the movable cylinder 27. The fixed cylinder 26 has a sealing surface 26c below the fixed opening 26a. The sealing surface 26c is an outer surface of a cylinder. The sealing surface 26c contacts the sealing member 35 to partition the clean side CS and the dirty side DS.

The movable cylinder 27 is a cylinder with a closed one end (upper end.) The movable cylinder 27 is movable with respect to the fixed cylinder 26 along the axis AX. The movable cylinder 27 is inserted inside the fixed cylinder 26. The movable cylinder 27 is arranged so as to project from the opening end 26b of the fixed cylinder 26. The movable cylinder 27 has a movable opening 27a that provides a valve mechanism described later. The movable opening 27a is formed by penetrating the wall of the movable cylinder 27 in an inside and outside manner. The movable cylinder 27 has a plurality of movable openings 27a that are arranged in a distributed manner along the circumferential direction of the movable barrel 27. The fixed opening 26a and the movable opening 27a are provided at corresponding positions in the circumferential direction so as to communicate with each other.

The movable cylinder 27 is located outside the fixed cylinder 26. In other words, the movable cylinder 27 projects from the fixed cylinder 26 to the outside of the fixed cylinder 26. The movable cylinder 27 has an end wall 27b located above the fixed cylinder 26. In the movable cylinder 27, the end wall 27b projects outward in the radial direction. The outer diameter of the end wall 27b is larger than the inner diameter of the fixed cylinder 26.

The movable cylinder 27 has a movable cylinder meshing portion 27c on the end wall 27b. The movable cylinder meshing portion 27c provides a meshing mechanism described later. The movable cylinder meshing portion 27c is formed on the end wall 27b of the movable cylinder 27 without providing an opening on the end wall 27b. The movable cylinder meshing portion 27c provides a convex portion and a concave portion.

The fixed cylinder 26 and the movable cylinder 27 provide a valve mechanism. The valve mechanism is provided by the fixed opening 26a and the movable opening 27a. The valve mechanism is formed between the fixed cylinder 26 and the movable cylinder 27. The valve mechanism opens at a position where the movable cylinder 27 is pushed, and closes at a position where the movable cylinder 27 extends. The valve mechanism suppresses foreign matter from entering the clean side CS in the support cylinder 25 in the operation of replacing the filter element 30. The valve mechanism does not provide a fully closed condition. The valve mechanism notifies that there is something wrong in the filter device 10 by limiting the fuel flow amount. The valve mechanism limits the flow amount of fuel so as to suppress the output of the internal combustion engine, for example. The valve mechanism may restrict flow amount, for example, if a filter element 30 did not attached thereto, the filter element 30 did not be attached at a proper position, or a improper filter element which did not have a shape to be able to operate appropriately the movable cylinder 27 was attached thereto.

An engaging mechanism 28 is provided between the fixed cylinder 26 and the movable cylinder 27. The engaging mechanism 28 connects the movable cylinder 27 to the fixed cylinder 26. The engaging mechanism 28 prevents the fixed barrel 26 and the movable barrel 27 from being separated from each other. The engaging mechanism 28 allows the movable cylinder 27 to move in the direction of the axis AX with respect to the fixed cylinder 26 within a predetermined restricted distance L28b. The engaging mechanism 28 restricts the movement of the movable cylinder 27 with respect to the fixed cylinder 26 in the circumferential direction. As a result, the movable cylinder 27 is supported so as to be movable in the direction of the axis AX with respect to the fixed cylinder 26. The movable cylinder 27 is restricted from moving with respect to the fixed cylinder 26 about the axis AX. In other words, the movable cylinder 27 is fixed to the fixed cylinder 26 around the axis AX.

The engaging mechanism 28 has a pin 28a and an oval opening portion 28b extending along the axis AX. The pin 28a is fixed to the fixed cylinder 26. The pin 28a is arranged so as to penetrate through the diameter of the fixed cylinder 26. The opening 28b is formed in the movable cylinder 27. The opening 28b receives the pin 28a. The opening 28b is a slit-shaped through hole. As a result, the movable range of the movable cylinder 27 is restricted to the movable range of the pin 28a in the opening 28b. The movable range of the movable cylinder 27 is the restricted distance L28b.

A biasing member 29 that biases the movable cylinder 27 in a direction in which the movable cylinder 27 is extended with respect to the fixed cylinder 26 is disposed between the fixed cylinder 26 and the movable cylinder 27. The biasing member 29 is disposed between the upper surface of the fixed cylinder 26 and the lower surface of the end wall 27b of the movable cylinder 27. The biasing member 29 is provided by a compressed coil spring.

<Filter Element>

The filter element 30 has a cylindrical shape. The filter element 30 is arranged in the case 20. The filter element 30 is arranged in the case 20 so as to cover the support cylinder 25. The filter element 30 has a filter medium 31 arranged in a cylindrical shape around the axis AX, and a frame 32 supporting the filter medium 31. The filter medium 31 is a so-called honeycomb type. The frame 32 has a core frame 33 and a side frame 34. The core frame 33 and the side frame 34 are fixed via the filter medium 31.

The core frame 33 has a support portion 33a that supports the filter medium 31. The honeycomb-type filter medium 31 is arranged around the support portion 33a. In the manufacturing method for manufacturing the honeycomb-type filter medium 31, the support portion 33a may be used as a winding core around which the honeycomb-type filter medium 31 is wound. The movable cylinder 27 is a cylinder with a closed one end (upper end.) As a result, the core frame 33 provides an inverted U-shaped member.

The core frame 33 has a protruding portion 33b. The protruding portion 33b is arranged above the support portion 33a. The protruding portion 33b protrudes from the filter medium 31 along the axis AX. The protruding portion 33b is a cap-shaped portion that covers the end wall 27b. The protruding portion 33b is arranged between the movable cylinder 27 and the second case 22. The support portion 33a and the protruding portion 33b are integrally formed of resin.

The core frame 33 has a frame meshing portion 33c. The frame meshing portion 33c is provided on the inner surface 33d of the protruding portion 33b facing the movable cylinder 27. The frame meshing portion 33c meshes with the movable cylinder meshing portion 27c.

The protruding portion 33b has a circular end portion 33e. The circular end portion 33e is a circular member around the axis AX at the end of the protruding portion 33b in the direction of the axis AX. The circular end portion 33e comes in contact with the second case 22. The circular end portion 33e contributes to suppressing friction between the second case 22 and the filter element 30. This suppresses an accompanying rotation of the filter element 30 when the second case 22 rotates. The protruding portion 33b includes multi-staged discs. The multi-staged discs are located at the ends of the filter element 30 in the direction of the axis AX. The multi-staged discs projects radially outward from the axis AX and are separated from each other in the direction of the axis AX. In the illustrated embodiment, two stages of discs are arranged. One of the discs is provided by the circular end portion 33e.

The side frame 34 is a member that extends from the outside of the filter medium 31 through the lower end of the filter medium 31 to the inside of the filter medium 31. The side frame 34 is an annular cup shape. The side frame 34 has an outer cylinder 34a located radially outside the filter medium 31, an inner cylinder 34b located inside the filter medium 31, and a bottom wall 34c connecting the outer cylinder 34a and the inner cylinder 34b. The inner cylinder 34b is located radially inward of the support portion 33a. The inner cylinder 34b is located between the support portion 33a and the fixed cylinder 26. The inner cylinder 34b extends from the bottom wall 34c along the axis AX. The inner cylinder 34b extends higher than the outer cylinder 34a. As a result, the side frame 34 provides an annular cup that houses the filter medium 31 and the lower portion of the support portion 33a. A gap is formed between the support portion 33a and the bottom wall 34c. The inner cylinder 34b has a stopper flange 34d which is an inner flange for a seal member 35 described later. The stopper flange 34d defines a position of the seal member 35. The frame 32 is a resin molded product. The support portion 33a and the protruding portion 33b are integrally formed of resin. The outer cylinder 34a, the inner cylinder 34b, and the bottom wall 34c are integrally formed of resin.

The filter device 10 has a seal member 35. The seal member 35 partitions the dirty side DS and the clean side CS. The seal member 35 is arranged between the filter element 30 and the support cylinder 25. The seal member 35 comes in contact with the inner cylinder 34b and the seal surface 26c. The sealing member 35 is held by the stopper flange 34d and a step that provides the sealing surface 26c. The relatively long inner cylinder 34b allows the seal member 35 to be arranged as high as possible. The seal member 35 arranged as high as possible facilitates replacement of the seal member 35. The seal member 35 is provided by an O-ring or the like.

The filter element 30 is arranged between the first case 21 and the second case 22 in a state where the first case 21 and the second case 22 are coupled at a prescribed position. The filter element 30 is arranged by compressing the biasing member 29 when the first case 21 and the second case 22 are coupled to each other at a prescribed position. The filter element 30 is biased by the biasing member 29 via the movable cylinder 27 so as to come into contact with the second case 22. As a result, the filter element 30 comes in contact with the second case 22.

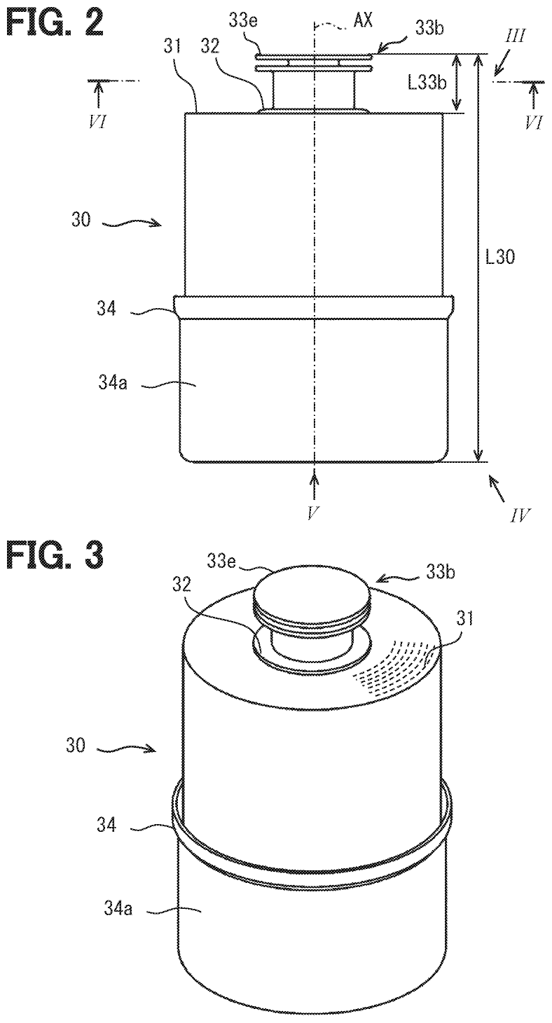

In FIG. 2, the filter element 30 has a length L30 in the direction of the axis AX. The length L30 is a length that allows the filter element 30 to be housed in the case 20 when the first case 21 and the second case 22 are coupled to each other at a prescribed position. The protruding portion 33b protrudes from the filter medium 31 by a length L33b along the axis AX. The protruding portion 33b projects from the upper end surface of the filter medium 31 by the length L33b. The length L33b is a part of the length L30.

FIG. 3 is a perspective view taken along the arrow III in FIG. 2. The protruding portion 33b is positioned so as to protrude above the filter medium 31. The circular end portion 33e is located away from the filter medium 31. The circular end 33e provides an umbrella-shaped protruding portion 33b that protrudes from the filter medium 31.

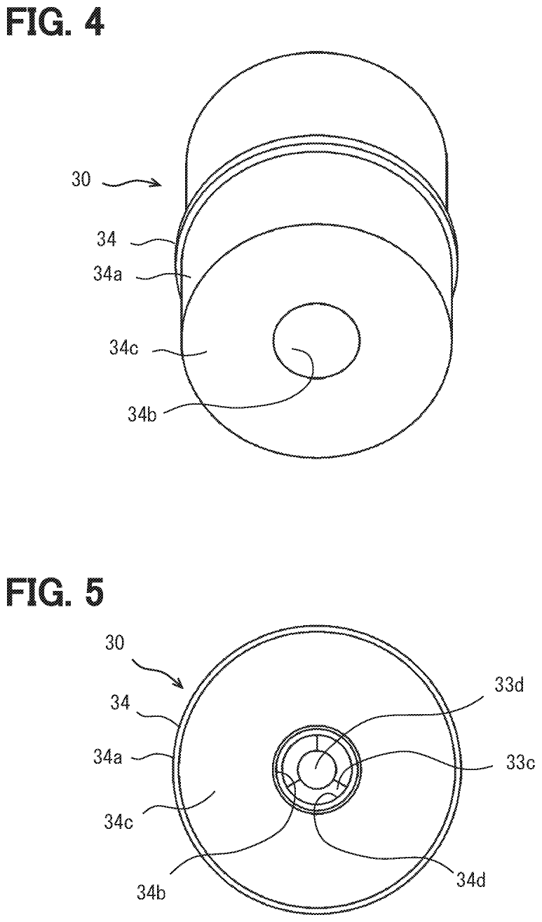

FIG. 4 is a perspective view taken along the arrow IV in FIG. 2. The filter element 30 provides a cylindrical cavity for receiving the support cylinder 25 by the inner cylinder 34b. In the method of manufacturing a filter device in which the filter element 30 is mounted on the case 20, the filter element 30 is mounted so as to cover the support cylinder 25. During the period in which the filter device 10 is used, the support cylinder 25 is housed in the inner cylinder 34b. In the method for disassembling the filter device in which the filter element 30 is separated from the case 20, the filter element 30 is pulled out from the first case 21.

<Meshing Mechanism>

FIG. 5 is a bottom view taken along the arrow V in FIG. 2. The stopper flange 34d, the frame meshing portion 33c, and the inner surface 33d are shown in the inner cylinder 34b. The frame meshing portion 33c provides three irregularities along the circumferential direction.

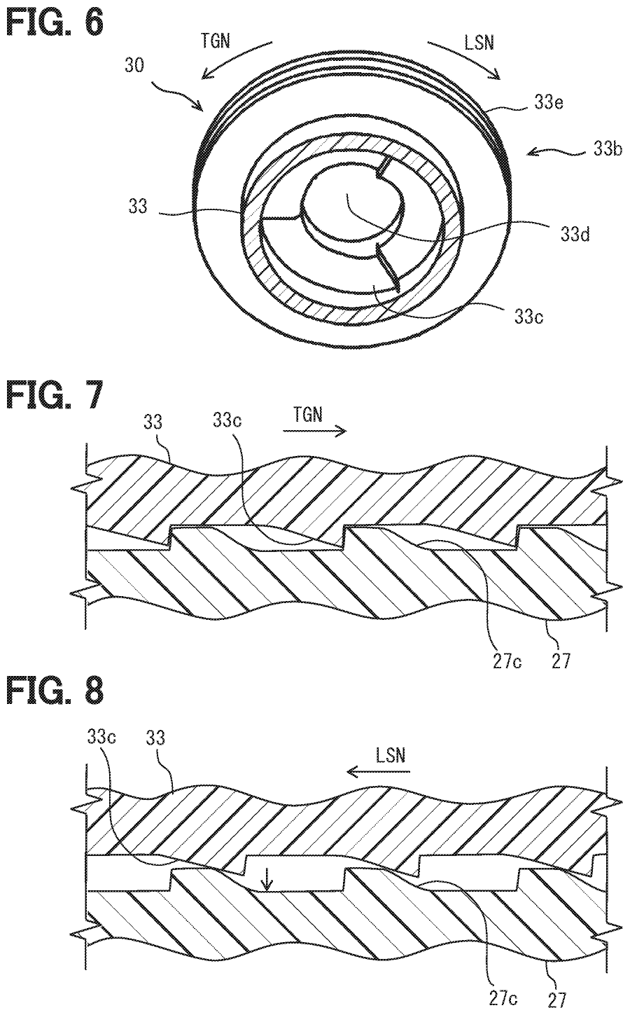

FIG. 6 is an enlarged perspective view showing a cross section along the arrow VI in FIG. 2. The frame meshing portion 33c has three irregularities arranged at equal angular intervals. One unevenness is provided by a right triangle. Corners of the right triangle are slightly rounded.

FIG. 7 and FIG. 8 are sectional views schematically showing the meshing mechanism. In the manufacturing method of mounting the filter element 30, the movable cylinder meshing portion 27c and the frame meshing portion 33c mesh with each other only by putting the filter element 30 to cover the support cylinder 25. When mounting the filter element 30 on the support cylinder 25, first, the filter element 30 is mounted on the movable cylinder 27 extending from the fixed cylinder 26. At this time, the meshing mechanism creates a meshing, and immediately after that, the rotation of the filter element 30 is blocked. The rotation of the filter element 30 is restricted to 120 degrees or less.

Next, the second case 22 is attached to the opening end 21c and is rotated in the tightening direction TGN. As a result, the second case 22 is gradually tightened. At the same time, the second case 22 tries to rotate the circular end portion 33e by coming into contact with the protruding portion 33b, but the circular end 33e is less likely to receive the rotational force due to a slip. The second case 22 gradually pushes the filter element 30 and the movable cylinder 27 in the axial direction. At this time, even if the filter element 30 tries to rotate in the tightening direction TGN, the meshing mechanism blocks the rotation of the filter element 30. The second case 22 is completely tightened to the first case 21 while the rotation of the filter element 30 is blocked.

When the second case 22 is rotated in the tightening direction TGN, the filter element 30 receives the rotational force in the tightening direction TGN. In this case, a vertical surface of the frame meshing portion 33c and a vertical surface of the movable cylinder meshing portion 27c abut against each other. As a result, the frame meshing portion 33c blocks the rotation of the filter element 30 by meshing with the movable cylinder meshing portion 27c. By blocking the rotation of the filter element 30, the sealing member 35 is pushed along the direction of the axis AX without being twisted.

On the other hand, when the second case 22 is rotated in the loosening direction LSN, the filter element 30 receives the rotational force in the loosening direction LSN. In a section where the biasing member 29 can be compressed, the frame meshing portion 33c and the movable cylinder meshing portion 27c move so as to slide on the triangular slopes without meshing with the movable cylinder meshing portion 27c. As a result, the rotation of the filter element 30 is allowed. When loosening the first case 21 and the second case 22, the rotation of the filter element 30 may help the movement of the filter element 30. Further, when the first case 21 and the second case 22 are loosened, the rotation of the filter element 30 may contribute to release a fixation between the seal member 35 and the seal surface 26c.

The meshing mechanism is formed at a contact portion between the support cylinder 25 and the filter element 30. The meshing mechanism is formed at a contact portion between the movable cylinder 27 and the frame 32. The meshing mechanism meshes so as to prevent the filter element 30 from rotating in the tightening direction TGN. The meshing mechanism allows the filter element 30 to rotate in the loosening direction LSN.

The meshing mechanism enables the valve mechanism to open when the movable cylinder meshing portion 27c of the movable cylinder 27 and the frame meshing portion 33c of the filter element 30 have proper shapes that can mesh with each other. Therefore, if the movable cylinder meshing portion 27c and/or the frame meshing portion 33c is not an authentic product, the valve mechanism may not open. In this case, the flow amount of fuel is limited. Thus, the meshing mechanism may contribute to reduce use of an inauthentic filter device 10 and/or an inauthentic filter element 30.

<Engaging Mechanism>

The engaging mechanism 28 engages the fixed cylinder 26 and the movable cylinder 27 in the direction of the axis AX. A movable distance of the movable cylinder 27 with respect to the fixed cylinder 26 is restricted in the restricted distance L28b by the engaging mechanism 28. Therefore, if the filter element 30 is replaced, even if the filter element 30 is pulled out from the first case 21, the movable cylinder 27 and the biasing member 29 are held by the fixed cylinder 26. As a result, the engaging mechanism 28 prevents dismantle of reusable parts.

The biasing member 29 biases the filter element 30 so as to push it out of the first case 21. When the first case 21 and the second case 22 are separated, the restricted distance L28b allowed by the engaging mechanism 28 is a distance which makes at least a part of the protruding portion 33b of the filter element 30 be projected from the opening end 21c of the first case 21. The restricted distance L28b is the distance that allows the multi-staged discs in the protruding portion 33b to protrude from the opening end 21c.

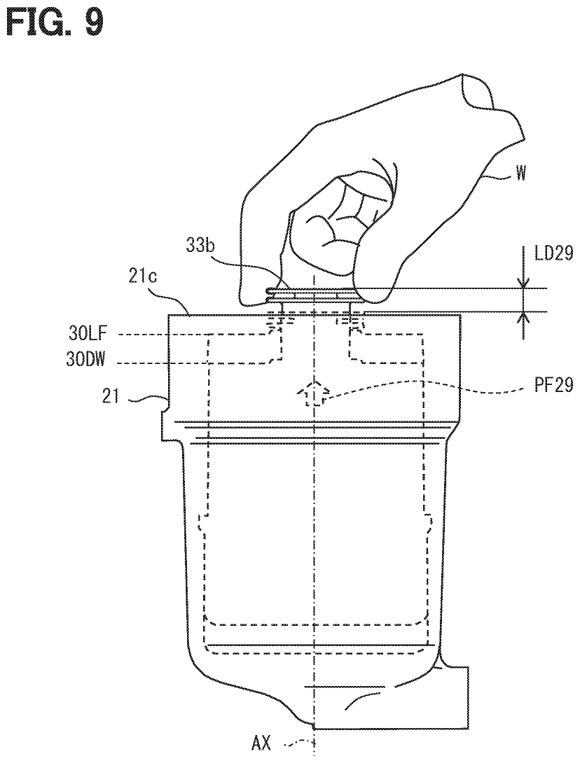

FIG. 9 shows a state in which the first case 21 and the second case 22 are separated during the replacement work of the filter element 30. In a state where the first case 21 and the second case 22 are connected at a proper position, that is, in the state shown in FIG. 1, the filter element 30 is in the use position 30DW. In the use position 30DW, the valve mechanism is open. At the use position 30DW, the protruding portion 33b protrudes slightly above the opening end 21c.

When the second case 22 is removed, the biasing force PF29 of the biasing member 29 pushes up the filter element 30 via the movable cylinder 27. The engaging mechanism 28 and the biasing member 29 push the filter element 30 up to the replacement position 30LF. In the exchange position 30LF, the valve mechanism is closed. As a result, the protruding portion 33b is pushed up by the distance LD29. The protruding portion 33b is made to protrude clearly above the opening end 21c. As a result, the filter element 30 can be gripped by the operator's hand W or a tool above the opening end 21c. The used filter element 30 can be replaced by grasping the protruding portion 33b.

When the used filter element 30 is pulled out from the first case 21, the liquid level of the fluid remaining in the first case 21 decreases. The cup-shaped shape of the side frame 34 stores a predetermined amount of fluid, and thus contributes to lowering the liquid level. In the preferred embodiment, when the filter element 30 is withdrawn, the liquid level drops below the fixed opening 26a. As a result, it is possible to prevent the residual fluid of the dirty side DS from entering the clean side CS in the support cylinder 25.

Then, a new filter element 30 is inserted into the first case 21. At this time, the remaining fluid passes through the outer cylinder 34a, permeates the filter medium 31, and is filtered. Further, the second case 22 is attached to the opening end 21c. Further, the second case 22 is rotated in the tightening direction TGN to gradually tighten the filter element 30. Also at this time, the residual fluid gets over the outer cylinder 34a lower than the inner cylinder 34b, permeates the filter medium 31, and is filtered. As a result, it is possible to prevent the residual fluid from passing through the gap between the fixed cylinder 26 and the inner cylinder 34b, further exceeding the seal member 35, and reaching the clean side CS.

<Operation>

Fuel is supplied from the fluid source 2 into the case 20. The fuel passes through the upper end surface of the filter medium 31 from the dirty side DS in the case 20, is filtered by the filter medium 31, and flows out to the lower end surface of the filter medium 31. The fuel flows through the annular passage between the lower end surface of the filter medium 31 and the bottom wall 34c into the cylindrical frame passage 32a between the support portion 33a and the inner cylinder 34b. The fuel is supplied from the frame passage 32a through the fixed opening 26a and the movable opening 27a in order, and is supplied to the utilization device 3 from the outlet 21e.

According to the embodiments described above, the meshing mechanism provides meshing to prevent rotation of the filter element 30 with respect to the tightening direction TGN. As a result, when the first case 21 and the second case 22 are relatively operated in the tightening direction TGN, the accompanying rotation of the filter element 30 is prevented. Thereby, the stress applied to the seal member 35 is suppressed, and the damage of the seal member 35 is suppressed.

According to this embodiment, the engaging mechanism 28 can lift the filter element 30 in the restricted distance L28b. The restricted distance L28b is a distance that allows at least a part of the protruding portion 33b to protrude from the opening end 21c of the first case 21 when the first case 21 and the second case 22 are separated. As a result, the operator can operate the protruding portion 33b of the filter element 30.

According to this embodiment, the filter element 30 has a protruding portion 33b protruding from the filter medium 31 along the axis AX. As a result, an operator may operate the protruding portion 33b while suppressing contact with the filter medium 31.

<Appearance of Filter Element>

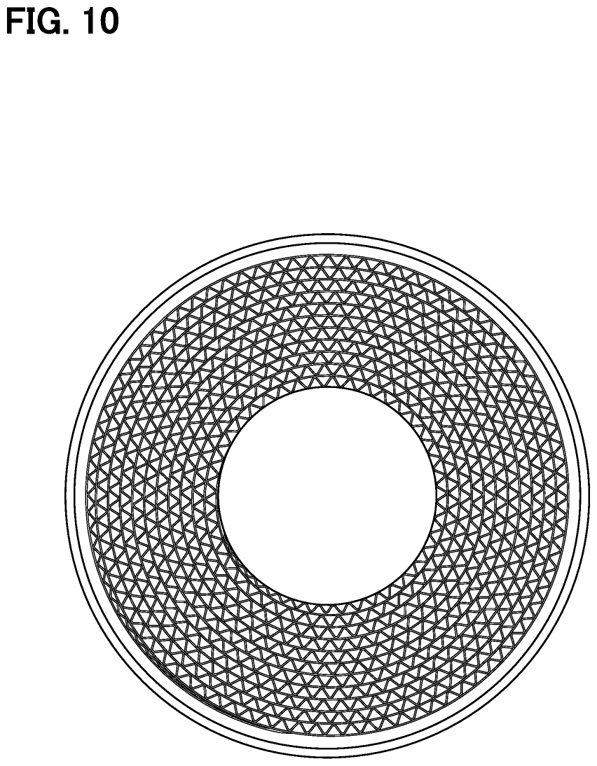

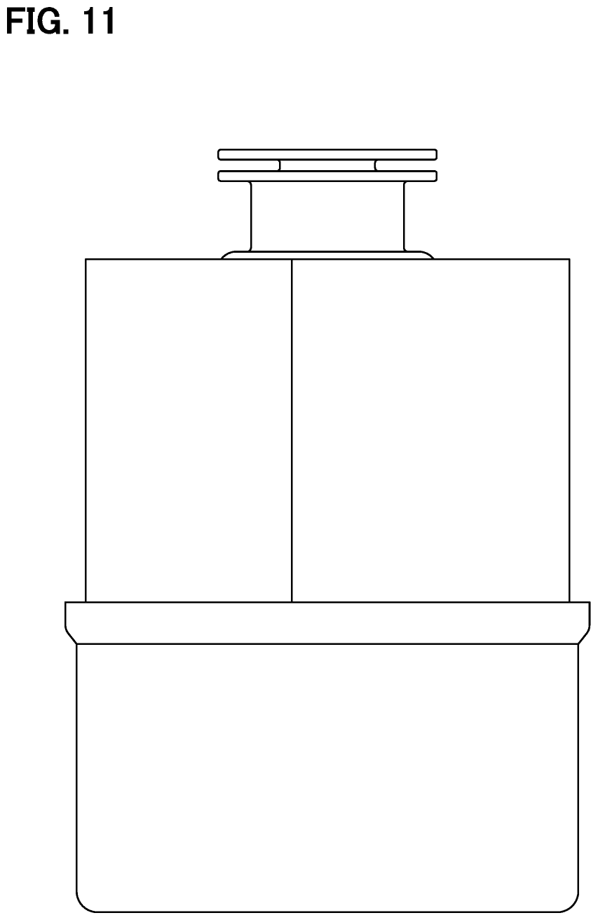

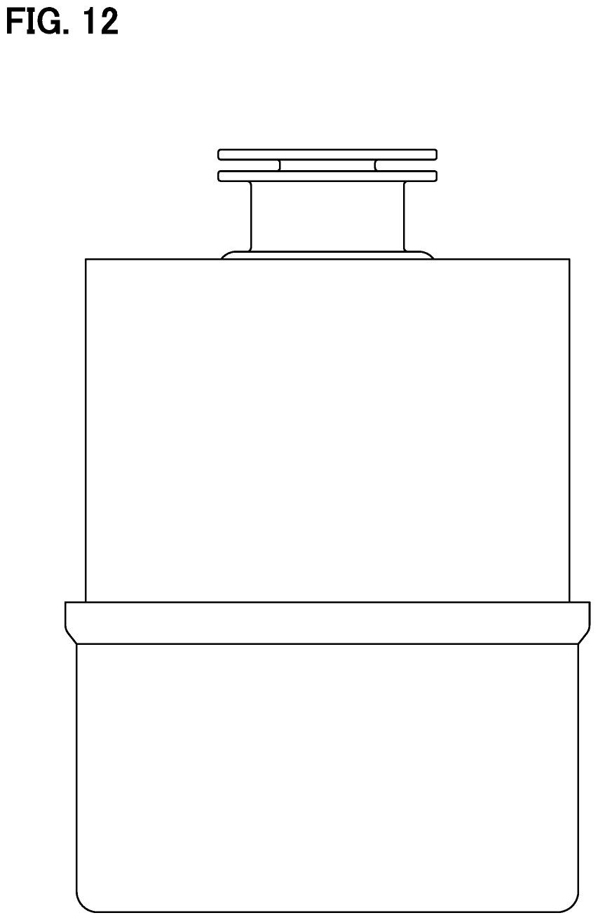

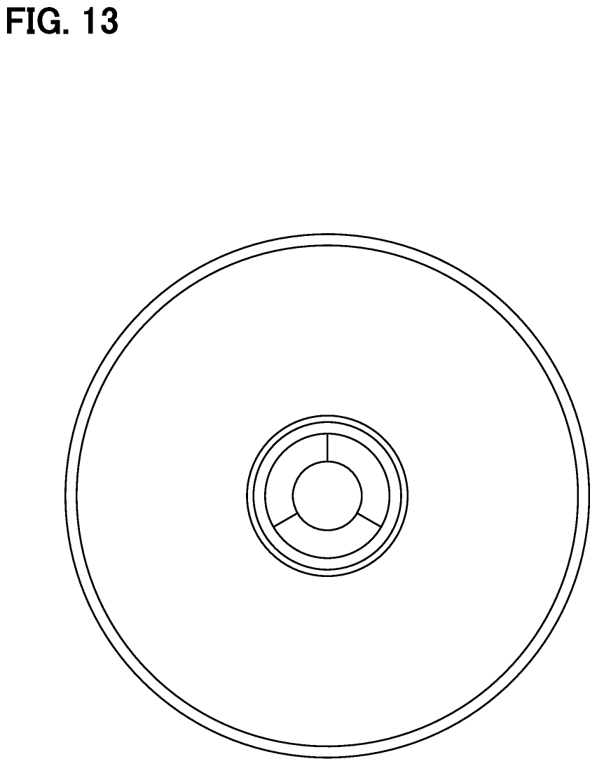

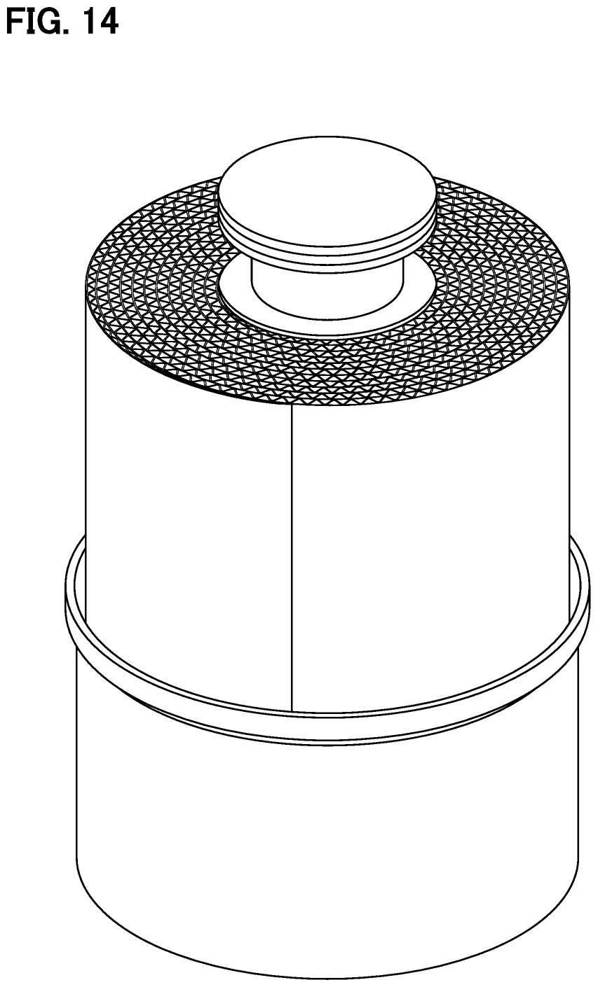

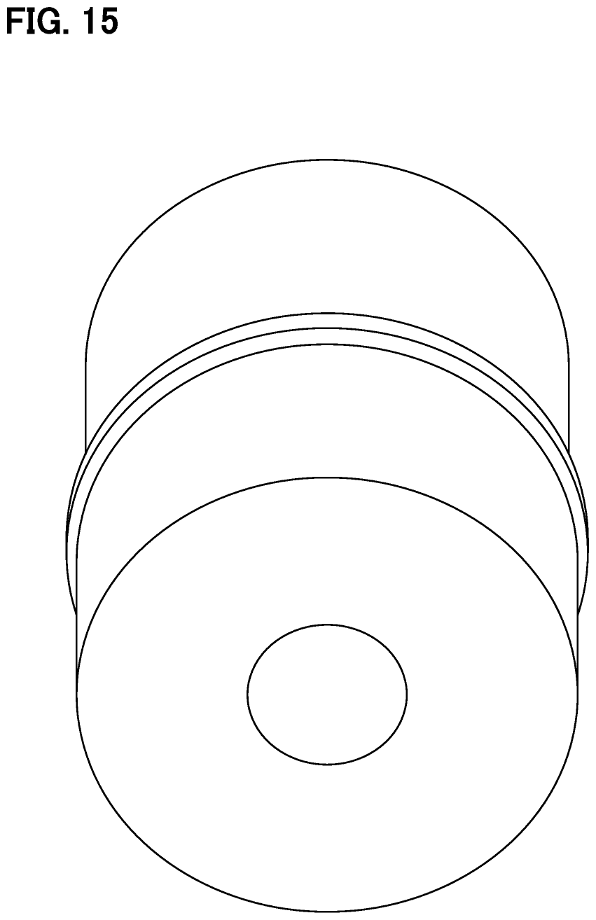

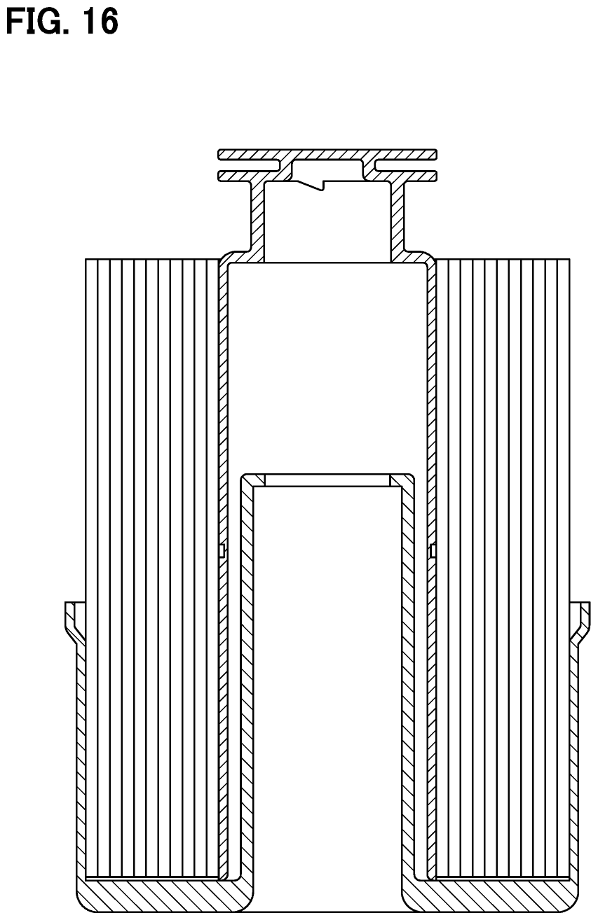

The frame 32 and the filter medium 31 are visible in an outer appearance of the filter element 30. The frame 32 appears as a surface of the molded resin. The filter medium 31 appears as the surface of the filter paper. FIG. 10 is a plan view of the filter element 30 according to the first embodiment. The pattern of the end surface of the filter medium 31 appears in the annular range. FIG. 11 is a frontal view of the filter element 30. The protruding portion 33b appears on the upper portion. Two quadrangles divided at approximately the center indicate the filter medium 31. The outer cylinder 34a of the side frame 34 appears at the lower portion. FIG. 12 is a side view of the filter element 30. A right side surface, a left side surface, and a back surface of the filter element 30 appear as same as in FIG. 12. FIG. 13 is a bottom view of the filter element 30. FIG. 14 is a perspective view of an upper portion of the filter element 30. FIG. 15 is a perspective view of a lower portion of the filter element 30. FIG. 16 is a cross-sectional view showing the internal structure of the filter element 30 for reference. When viewed as a design, the protruding portion 33b is a portion that is about to receive design registration as a partial design. The protruding portion 33b appears in the center of FIG. 10 in a circular shape, and in the upper portion of FIG. 11 as four quadrangles protruding slightly thinner than others. The portions other than the protruding portion 33b are other portions than the portion that is going to receive the design registration.

### Second Embodiment

This embodiment is a modification based on the preceding embodiment. In the above-described embodiment, the meshing mechanism between the core frame 33 and the movable cylinder 27 is provided by a shallow meshing portion. Alternatively, the meshing mechanism may include a deeper meshing portion.

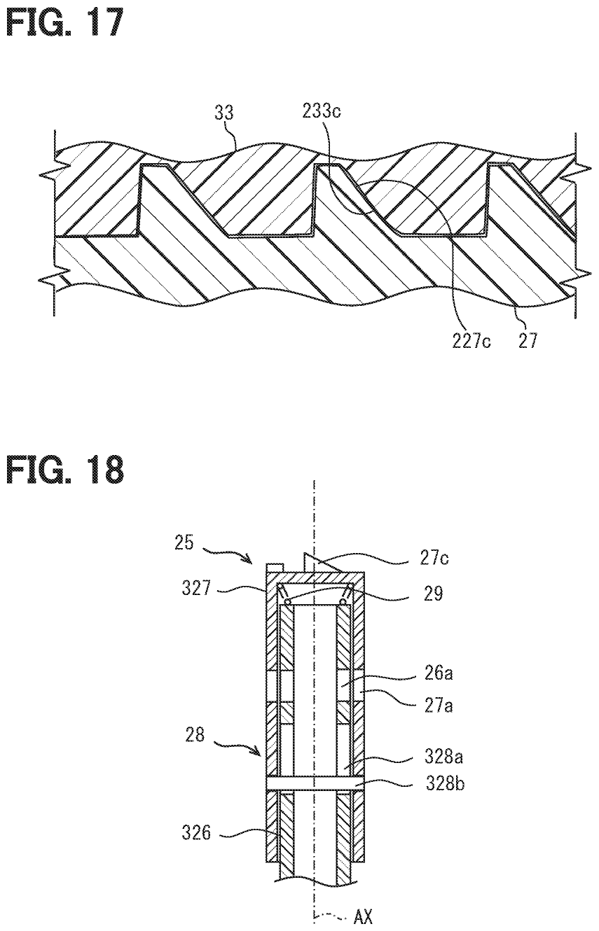

In FIG. 17, the meshing mechanism has a movable cylinder meshing portion 227c and a frame meshing portion 233c. The shape of such an meshing mechanism contributes to reduce use of an inauthentic filter device and/or filter element. Also in this embodiment, the same effects as those of the preceding embodiments can be obtained.

### Third Embodiment

This embodiment is a modification based on the preceding embodiment. In the above embodiment, the movable cylinder 27 is arranged inside the fixed cylinder 26. Alternatively, the support cylinder 25 may be arranged in various ways.

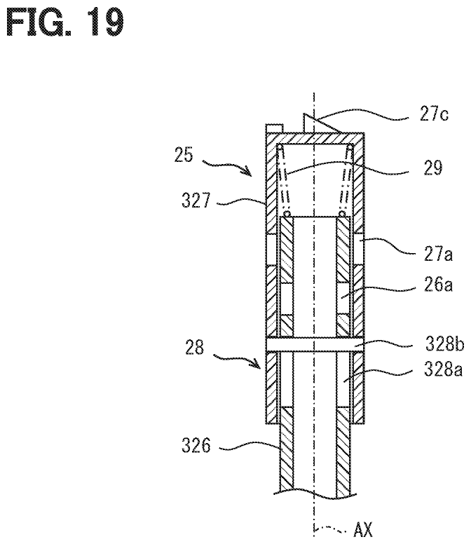

FIG. 18 and FIG. 19 illustrate the support cylinder 25 including the fixed cylinder 326 and the movable cylinder 327. In this embodiment, the movable cylinder 327 is arranged outside the fixed cylinder 326. The engaging mechanism 28 includes an opening 328a formed on the fixed cylinder 326 and a pin 328b fixed to the movable cylinder 327. Even with this arrangement, the movable range of the movable cylinder 327 along the direction of the axis AX can be restricted within the restricted range. Moreover, the rotation of the movable cylinder 327 can be restricted so as not to substantially rotate with respect to the fixed cylinder 326. Further, the engaging mechanism 28 is arranged below the valve mechanism. Also in this embodiment, the same effects as those of the preceding embodiments can be obtained.

### Fourth Embodiment

This embodiment is a modification based on the preceding embodiment. In the above-described embodiment, the honeycomb-type filter medium 31 that mainly causes the fluid to flow in the axial direction is used. Alternatively, the filter element 30 may employ various types of filter media.

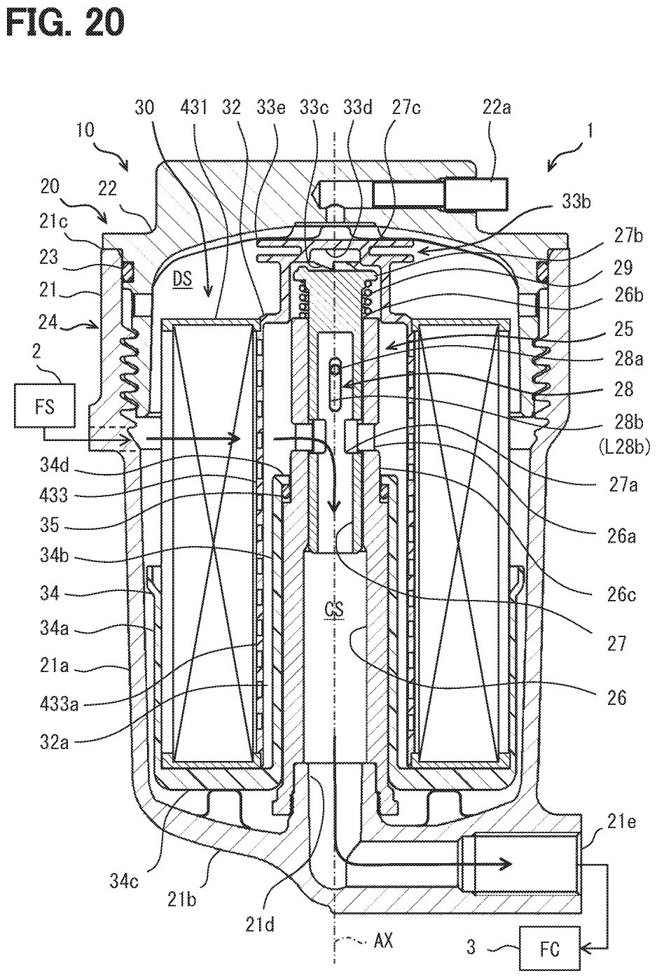

FIG. 20 shows a filter medium 431 called a chrysanthemum-shaped or star-shaped filter that mainly causes fluid to flow in the radial direction. The filter medium 431 is supported on the radially outer side of the core frame 433. The support portion 433a of the core frame 433 has a plurality of passage openings. Also in this embodiment, the same effects as those of the preceding embodiments can be obtained.

### Other Embodiments

The disclosure in this specification, the drawings, and the like is not limited to the illustrated embodiments. The disclosure encompasses the illustrated embodiments and variations thereof by those skilled in the art. For example, the present disclosure is not limited to the combinations of components and/or elements shown in the embodiments. The present disclosure may be implemented in various combinations. The present disclosure may have additional portions which may be added to the embodiments. The present disclosure encompasses omission of the components and/or elements of the embodiments. The present disclosure encompasses the replacement or combination of components and/or elements between one embodiment and another. The disclosed technical scope is not limited to the description of the embodiment. Several technical scopes disclosed are indicated by descriptions in the claims and should be understood to include all modifications within the meaning and scope equivalent to the descriptions in the claims.

In the above embodiment, the fuel has been described as the fluid to be filtered. Instead, the present disclosure is applicable to filter devices and filter elements that filter various fluids such as water, refrigerant, and oil.

In the above embodiment, the screw mechanism is adopted as the fastening mechanism 24. Alternatively, various fastening mechanisms such as a bayonet lock mechanism, a bolt fastening mechanism, and a retainer fastening mechanism may be adopted. Further, in the above-described embodiment, the example in which the first case 21 is the fixed side and the second case 22 is removed has been described. Alternatively, the first case 21 may be removed with the second case 22 as the fixed side.

In the above embodiment, the honeycomb-type filter medium 31 or the chrysanthemum-shaped filter medium 431 has been described. Alternatively, the filter element 30 can utilize various filter media such as a spiral type and a molded body type.

In the above embodiment, the valve mechanism is provided by the fixed opening 26a and the movable opening 27a that are aligned in the radial direction at a regular valve opening position in which the movable cylinder 27 is pushed inwardly. Alternatively, the valve mechanism may have a circumferential groove formed in the fixed cylinder 26 and/or the movable cylinder 27. In addition to the shutter-type valve mechanism shown in the figure, a valve element operated by the movable cylinder 27 may be included.

WO2009/048670 is incorporated herein by reference to explain a comparative example. In this comparative example, a valve element is operated from a closed position to an open position when an authentic filter element is mounted in a proper position. In one aspect, in the comparative example, a sealing member that separates a clean side and a dirty side may be damaged when a case is fastened. Since the filter element rotates together with a valve cap, the seal member may receive a stress in a rotational direction and may be damaged. Further, in a configuration in which the case is rotated in a tightening direction to close the case, the filter element may rotate together.

In another aspect, the comparative example may require complicated replacement work. This is because, when the filter element is replaced, multiple parts may not be disassembled as expected. For example, when retrieving a used filter element, multiple reusable parts may be retrieved with the filter element. In another aspect, the comparative example is not easy to handle the element. For example, a large amount of fluid to be filtered may adhere to an operator's hand or tool. In another aspect, in the conventional technique, foreign matter may enter the clean side. This is because the comparative example has an opening in an end wall of a valve cap due to an engagement of a projection provided on the element with the valve cap. In another aspect, the comparative example may leave the sealing member at a bottom of a central pipe when removing a used element. In this case, the seal member is left behind on the bottom of the case.

It is an advantage of the embodiment to provide a filter device that can suppress damage to a seal member. It is another advantage of the embodiment to provide a filter device that enables an easy replacing work. It is another advantage of the embodiment to provide a filter element that is easy to handle.

What is claimed is:

1. A filter device comprising:
A case having a first case and a second case which is rotated in a tightening direction and is coupled to the first case so as to cover an opening end of the first case;
a fixed cylinder fixed to the case, the fixed cylinder providing an outlet passage therein;
a movable cylinder which is movably supported in a direction of an axis with respect to the fixed cylinder and fixed around the axis with respect to the fixed cylinder;
a valve mechanism formed between the fixed cylinder and the movable cylinder, which opens at a position where the movable cylinder is pushed in and closes at a position where the movable cylinder extends;
a biasing member which biases the movable cylinder in a direction in which the movable cylinder is extended with respect to the fixed cylinder;
a cylindrical filter element arranged in the case so as to cover a support cylinder including the fixed cylinder and the movable cylinder;
a seal member disposed between the filter element and the support cylinder, for partitioning a dirty side before being filtered by the filter element and a clean side after being filtered by the filter element; and
a meshing mechanism formed at a contact portion between the support cylinder and the filter element, and meshing with each other so as to prevent rotation of the filter element in the tightening direction.

2. The filter device claimed in claim 1, wherein
the filter element includes:
a filter medium arranged in a cylindrical shape around the axis; and
a frame which supports the filter medium, and
the meshing mechanism includes:
a movable cylinder meshing portion formed on an end wall of the movable cylinder without providing an opening; and
a frame engaging portion provided on the frame and engaging with the movable cylinder meshing portion.

3. The filter device claimed in claim 1, wherein
the first case and the second case are separated by being rotated in a loosening direction opposite to the tightening direction, and wherein
the meshing mechanism allows rotation of the filter element in the loosening direction.

4. The filter device claimed in claim 1, further comprising
an engaging mechanism which engages the movable cylinder to the fixed cylinder so that a movement of the movable cylinder in the axial direction with respect to the fixed cylinder is allowed only by a predetermined restricted distance, wherein
the filter element includes:
a filter medium arranged in a cylindrical shape around the axis; and
a frame which supports the filter medium, and
the frame includes:
a support portion which supports the filter medium; and
a protruding portion provided on the support portion and protruding from the filter medium along the axis, and wherein
the filter element is arranged by compressing the biasing member when the first case and the second case are coupled to each other at a prescribed position, and wherein
the restricted distance allowed by the engaging mechanism is a distance that causes at least a portion of the protruding portion of the filter element to protrude from the opening end of the first case when the first case and the second case are separated.

5. A filter device comprising:
a case having a first case and a second case which is coupled to the first case so as to cover an opening end of the first case;
a cylindrical filter element arranged in the case; and
a support cylinder arranged in the case and extending in a direction of the axis of the filter element, wherein
the support cylinder includes:
a fixed cylinder fixed to the case, the fixed cylinder providing an outlet passage therein;
a movable cylinder which is movably supported in a direction of an axis with respect to the fixed cylinder and fixed around the axis with respect to the fixed cylinder;
a valve mechanism formed between the fixed cylinder and the movable cylinder, which opens at a position where the movable cylinder is pushed in and closes at a position where the movable cylinder extends;
a biasing member which biases the movable cylinder in a direction in which the movable cylinder is extended with respect to the fixed cylinder; and
an engaging mechanism which engages the movable cylinder to the fixed cylinder so that a movement of the movable cylinder in the axial direction with respect to the fixed cylinder is allowed only by a predetermined restricted distance, and wherein
the filter element includes:
a filter medium arranged in a cylindrical shape around the axis; and
a frame which supports the filter medium, and wherein
the frame includes:
a support portion which supports the filter medium; and
a protruding portion provided on the support portion and protruding from the filter medium along the axis, and wherein
the filter element is arranged by compressing the biasing member when the first case and the second case are coupled to each other at a prescribed position, and wherein
the restricted distance allowed by the engaging mechanism is a distance that causes at least a portion of the protruding portion of the filter element to protrude from the opening end of the first case when the first case and the second case are separated.

6. The filter device claimed in claim 5, wherein
the protruding portion includes
a circular end portion on an end portion in the direction of the axis, which is circular around the axis and comes in contact with the second case.

7. The filter device claimed in claim 5, wherein
the protruding portion includes
multi-staged discs on an end portion in the axial direction, which protrude radially outward from the shaft and are separated from each other in the axial direction, at the ends in the axial direction.

8. A filter element comprising:
a filter medium arranged in a cylindrical shape around an axis; and
a frame which supports the filter medium, wherein
the frame includes:
a support portion which supports the filter medium; and
a protruding portion provided on the support portion and protruding from the filter medium along the axis.

9. The filter element claimed in claim 8, wherein
the protruding portion includes
a circular end portion, which is circular around the axis, is provided on an end portion in the direction of the axis.

10. The filter element claimed in claim 9, wherein
the protruding portion includes
multi-staged discs on an end portion in the axial direction, which protrude radially outward from the axis and are separated from each other in the axial direction.
